(19) United States
(12) Patent Application Publication
(10) Pub. No.: US 2004/0077380 A1
(43) Pub. Date: Apr. 22, 2004

(54) Communication terminal for providing user information of receiving party and method thereof

(75) Inventor: Jae-Sun Park, Suwon-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/426,333

(22) Filed: Apr. 30, 2003

(30) Foreign Application Priority Data
Oct. 17, 2002 (KR) 2002-63504

(51) Int. Cl. H04M 1/00

(52) U.S. Cl. 455/566; 455/550.1

(57) ABSTRACT

A communication terminal for providing user information of a receiving party and a method thereof. The communication terminal includes a speaker section, a display section for displaying an operational state of the terminal and contents of external inputs, a communication interface section for providing a communication interface with an external network connection device, a memory section for storing/managing operational information including basic operational information, additional service information and user information for every phone number registered by a user, and a main processing section for reading out from the memory section the user information of a receiving party corresponding to a phone number of the receiving party inputted to the terminal when an originating call service using the terminal is requested, requesting the user information of the receiving party corresponding to the phone number of the receiving party that is not registered in the memory section from the external network connection device through the communication interface, and providing the user information of the receiving party transferred from the external network device to an originating party through at least one of the speaker section and the display section.

### PRIORITY

This application claims priority to an application entitled “Communication terminal for providing user information of receiving party and method thereof” filed in the Korean Industrial Property Office on Oct. 17, 2002 and assigned Ser. No. 2002-63504, the contents of which are hereby incorporated by reference herein.

### BACKGROUND OF THE INVENTION

1. Field of the Invention

The present invention relates to a mobile communication terminal, and more particularly to a communication terminal for providing user information of a receiving party and a method thereof capable of obtaining user information of a receiving party from a network apparatus (for example, base station, mobile switching center, etc.), and providing the user information to an originating party.

2. Description of the Related Art

In existing communication terminals (for example, wire/wireless phones, mobile communication terminals, etc.), if an originating party inputs a phone number for making a call, it is determined by the originating party's terminal whether the inputted phone number is stored in a memory (typically, a phone book) inside the terminal. If so, user information of a receiving party (typically, name of the receiving party) is displayed on a display window. However, this only occurs when the user information of the receiving party corresponding to the phone number is pre-stored in the memory of the originating party's terminal. If the user information of the receiving party is not stored in the memory of the terminal, only the phone number that has been inputted by the originating party is displayed on the display window of the originating party's terminal.

FIG. 1 is a flowchart illustrating a conventional method of providing user information of a receiving party. Referring to FIG. 1, if an originating party inputs a phone number for making a call (step S11), the phone number is displayed on a display window of a terminal (step S13), and if a call request command (e.g., “send”) for the inputted phone number is inputted (step S15), it is determined whether the phone number inputted at step S11 is stored in the memory of the originating terminal (step S17). If it is confirmed that the phone number inputted at step S11 is stored in the corresponding terminal, the user information corresponding to the phone number (i.e., the user information of the receiving party) is detected, and displayed on the display window of the terminal.

However, in the event that the originating party makes a call to a phone number that is not stored in the memory of the terminal, the user information of the receiving party corresponding to that phone number cannot be displayed on the terminal. Thus, the originating party cannot confirm the user information of the receiving party corresponding with the phone number inputted by himself/herself prior to the call connection. Accordingly, if the originating party cannot accurately remember the phone number, the call may be connected to a receiving party to whom the originating party did not intend to make a call.

Also, if the originating party does not remember the name of the receiving party, but only remember the phone number, the originating party may be unable to properly address or greet the receiving party, resulting in an embarrassing situation.

### SUMMARY OF THE INVENTION

Accordingly, the present invention has been made to solve the above-mentioned problems occurring in the prior art, and a first object of the present invention is to provide a communication terminal which, when the originating party inputs a phone number of a receiving party in order to make a call and then requests an originating call service to an external network device, provides user information of a receiving party corresponding to an inputted phone number of the receiving party irrespective of whether or not the inputted phone number is stored in a terminal of an originating party.

It is a second object of the present invention to provide a method of providing user information of a receiving party to a communication terminal of an originating party which provides the originating party with the user information of the receiving party corresponding to an inputted phone number of the receiving party irrespective of whether or not the inputted phone number is stored in the terminal of the originating party.

It is a third object of the present invention to provide a method of providing user information of a receiving party to a communication terminal of an originating party which provides the originating party with the user information of the receiving party corresponding to an inputted phone number of the receiving party if the inputted phone number of the receiving party is not stored in the terminal of the originating party.

It is a fourth object of the present invention to provide a method of providing user information of a receiving party to an external network device such as a base station thus enabling the network device to provide an originating party with the user information of the receiving party when an originating call service is requested from a communication terminal.

In order to accomplish the first object of the present invention, there is provided a communication terminal comprising a speaker, a display for displaying an operational state of the terminal and contents of external inputs to the terminal, a communication interface for providing a communication interface with an external network device, and a memory for storing user information for phone numbers registered by a user. In addition, the communication terminal comprises a main processor for, when an originating call service using the terminal is requested, retrieving from the memory the user information of a receiving party corresponding to the phone number of the receiving party inputted to the terminal, requesting user information of the receiving party corresponding to the phone number that is not registered in the memory from the external network device through the communication interface, and providing the user information of the receiving party transferred from the external network device to the originating party through at least one of the speaker and the display.

In order to accomplish the second object, there is provided a method of providing user information of a receiving party for a communication terminal of an originating party, comprising a first step of requesting from an external network device the user information of the receiving party that corresponds to a phone number of the receiving party inputted to the terminal when an originating call service is requested, and a second step of providing to the originating party the user information of the receiving party received from the external network device in response to the request of the first step.

In order to accomplish the third object, there is provided a method of providing user information of a receiving party for a communication terminal of an originating party, comprising a first step of, if an originating call service through the terminal has been requested, determining whether the user information of the receiving party that corresponds to a phone number of the receiving party inputted to the terminal is registered in an internal memory of the terminal of the originating party, a second step of providing to the originating party the user information of the receiving party that corresponds to the phone number of the receiving party if registered in the internal memory of the terminal of the originating party, a third step of requesting from an external network device the user information of the receiving party that corresponds to the phone number of the receiving party not having been registered in the internal memory of the terminal of the originating party, and a fourth step of providing to the originating party the user information of the receiving party received from the external network device in response to the request at the third step.

In order to accomplish the fourth object, there is provided a method of providing user information for a network connection device, comprising a first step of constructing a user information management database section for storing/managing the user information of service subscribers using a call service supported through the network connection device, a second step of, in the user information management database section, detecting the user information of a receiving party that corresponds to a phone number of the receiving party in response to a request for the user information of the receiving party from a terminal having requested an originating call service, and a third step of transmitting to the terminal the detected user information of the receiving party based on a predetermined data format.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart illustrating a conventional method of providing user information of a receiving party.

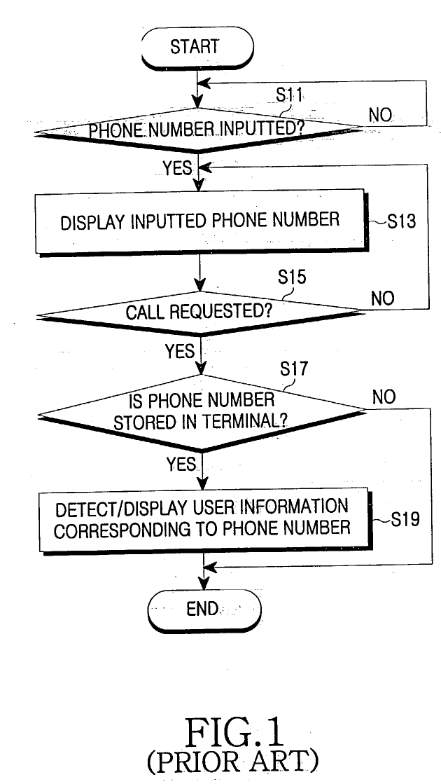

FIG. 2 is a schematic block diagram of a communication terminal that provides user information of a receiving party according to an embodiment of the present invention.

FIG. 3 is a flowchart illustrating a method of providing user information of a receiving party according to an embodiment of the present invention.

FIG. 4 is a flowchart illustrating a process of displaying user information received from outside an originating terminal according to an embodiment of the present invention.

FIG. 5 is a view illustrating a process of providing user information of a receiving party according to an embodiment of the present invention.

FIGS. 6A and 6B are views illustrating an example of a data format transmitted/received between a terminal and a base station for providing user information of a receiving party according to an embodiment of the present invention.

### DETAILED DESCRIPTION OF THE PREFERRED EMBODIMENT

Hereinafter, a communication terminal for providing user information of a receiving party and a method thereof according to the preferred embodiment of the present invention will be described with reference to the accompanying drawings. In the following description of the present invention, a detailed description of known functions and configurations incorporated herein will be omitted when it is well-known in the art.

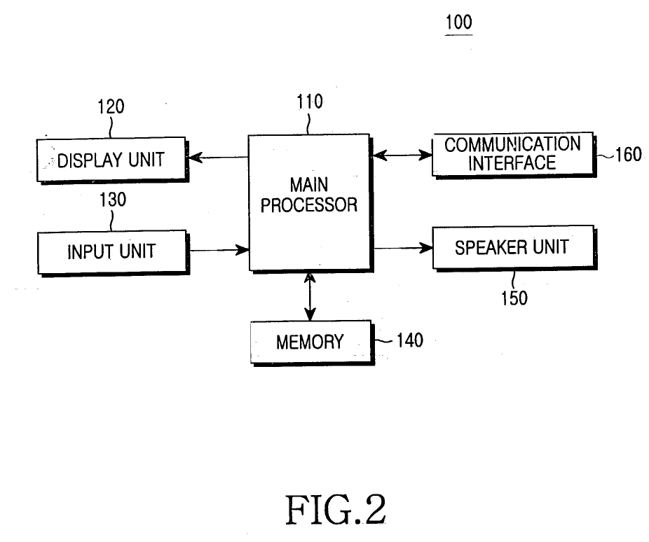

FIG. 2 is a schematic block diagram of a communication terminal that provides user information of a receiving party according to an embodiment of the present invention.

Referring to FIG. 2, the communication terminal 100 according to the embodiment of the present invention includes a main processor 110, a display unit 120, an input unit 130, a memory 140, a speaker unit 150, and a communication interface 160.

The input unit 130 and the speaker unit 150 are devices for providing an interface between the communication terminal 100 and a user, and are commonly included in general communication terminals (for example, wire/wireless phones and mobile communication terminals) along with a microphone (not illustrated). Accordingly, the detailed explanation thereof will be omitted.

The display unit 120 displays the operational state of the terminal 100 and external inputs. The communication interface 160 provides a communication interface with an external network device.

The external network device comprises an external information source. The external network device may be an external network connection device or system that supports a call service between the terminal and the network such as a switching center of a public switched telephone network (PSTN) and a base station of a public land mobile network (PLMN). Such external network connection devices are well known in the art, and the detailed explanation thereof will be omitted hereinafter. Alternatively, the external network device that supports the external information source may be a separate device that interfaces with an external network connection device.

The memory 140 stores/manages operational information, which includes basic operational information of the terminal 100, additional service information, and user information for phone numbers pre-registered by a user. Basic operational information refers to information for supporting a call service function that is a principle function of the terminal 100 itself, and additional service information refers to services (for example, alarm, morning call, etc.) serviceable in the terminal 100 in addition to the call service function. The user information for phone numbers, a so-called “phone book”, refers to storage and management of user names which correspond to phone numbers. The memory 140 stores and manages the user information for every phone number as audio voice data, text data, and/or image data (for example, photograph, photo card, etc.).

The main processor 110, if the originating party of the terminal 100 requests an originating call service using the terminal 100, provides to the originating party the user information of the receiving party that corresponds to the inputted phone number of the receiving party. That is, the main processor 110 extracts the user information of a receiving party that corresponds to the phone number of that receiving party from the memory 140, or receives the user information of a receiving party that corresponds to the phone number of a receiving party which is not registered in the memory 140 from the external network device through the communication interface 160, as further described below. The main processor 110 then provides the received user information to the originating party using at least one of the display unit 120 and the speaker unit 150. For example, the main processor 110 uses the speaker unit 150 if the user information of the receiving party is comprised of voice data, and uses the display unit 120 where the user information of the receiving party is comprised of text data or image data. If the user information of the receiving party is comprised of both voice data and text data, the main processor 110 provides the user information of the receiving party using both the display unit 120 and the speaker unit 150.

Also, the main processor 110 provides the user information of the receiving party to the originating party prior to the time point where the call is connected between the terminal of the originating party and the terminal of the receiving party. This provides the originating party advance confirmation of the user information of the receiving party through display of the user information of the receiving party on the terminal of the originating party. The originating party may thus cancel the originating call service request before the call is connected if the receiving party is not the person whom the originating party intended to call. This function will be commonly applied in the following description.

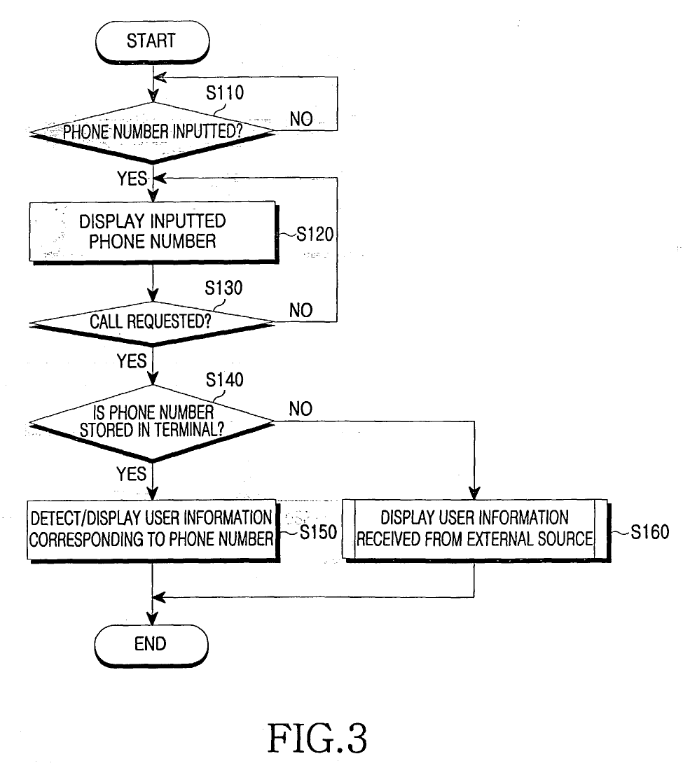

FIG. 3 is a flowchart illustrating a method of providing user information of a receiving party according to an embodiment of the present invention.

Referring to FIGS. 2 and 3, the method of providing user information of a receiving party according to the present invention will be explained.

If the originating party inputs the phone number of the receiving party using the input unit 130 for making a phone call (step S110), the main processor 110 displays the phone number of the receiving party on the display section 120 (step S120). Then, if the call request command is inputted for the phone number (step S130), i.e., if the originating call service is requested, the main processor 110 determines whether the phone number of the receiving party inputted at step S110 is stored in the memory 140 (step S140).

Storage of the phone number of the receiving party in the memory 140 means that user information of the receiving party that corresponds to the phone number of the receiving party is preregistered. Thus, if the phone number of the receiving party is determined to be stored in the memory 140 (step S140), the main processor 110 retrieves from memory 140 the user information of the receiving party corresponding to the inputted phone number of the receiving party and displays the user information of the receiving party on the display unit 120 (step S150).

If the phone number of the receiving party is determined as not stored in the memory 140 in step S140, the main processor 110 transmits the phone number to an external information source of an external network device via communication interface 160 and receives the user information that corresponds to the phone number of the receiving party from the external information source, and displays the received user information of the receiving party on the display section 120 (step S160).

It is preferable that the time at which the main processing section 110 provides the user information of the receiving party to the originating party is prior to the time at which the call is connected between the terminal of the originating party and the terminal of the receiving party.

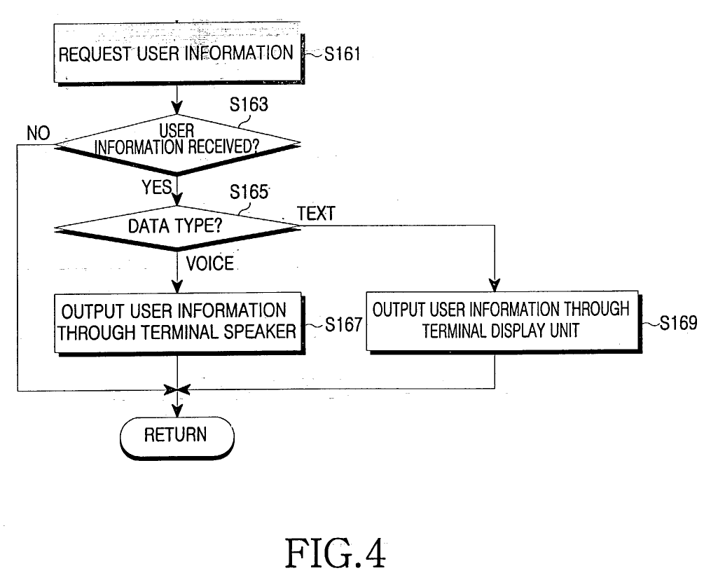

In FIG. 3, an example is given of the processing method in case that the user information of the receiving party is registered as text data. However, the terminal 100 will operate in the same manner as described above if the user information of the receiving party is registered as image data, and it is clear that the terminal 100 will provide the user information of the receiving party to the originating party through the speaker section 150 if the user information of the receiving party is registered as voice data. This function will be commonly described with respect to FIG. 4.

FIG. 4 is a flowchart illustrating the process (step S160) of displaying user information received from the external source according to an embodiment of the present invention.

Referring to FIGS. 2 and 4, if the phone number of the receiving party inputted by the originating party for making a call is not registered in the memory 140 of the terminal 100, the main processor 110 requests from the external network device (which comprises an external information source) the user information of the receiving party that corresponds to the phone number of the receiving party inputted by the user. The request is sent to the external network device through the communication interface 160 (step S161).

Then, if the user information of the receiving party is received in response to the request at step S161 (step S163), the main processor 110 confirms the data type, and provides the user information in the form of at least one of voice, text, and image, in accordance with the data type (steps s165 to S169). That is, if the type of user information of the receiving party is comprised of voice, the main processing section 110 outputs the user information through the speaker unit 150 (step S167), and if the type of the user information is comprised of text or image, it displays the user information on the display unit 120 (step S169).

Referring to FIGS. 2 and 4 requesting the user information of the receiving party that corresponds to the phone number from the external network device is made only if the phone number of the receiving party is not registered in the memory 140 of the terminal 100.

However, the present invention is not limited to that case. For example, it is also possible to request the user information of the receiving party from the network device simultaneously with the originating call service request, without searching the memory 140 of the terminal 100 being used by the originating party.

Specifically, in the method of providing the user information of a receiving party for the terminal of an originating party, when the originating call service is requested, it is also possible to request the user information of the receiving party that corresponds to the phone number of a receiving party having been inputted to the terminal and then to provide the user information to the originating party in the form of at least one of voice, text, and image, in response to the request. Otherwise, the steps of acquiring the user information of the receiving party are the same as those explained with reference to FIGS. 2 to 4.

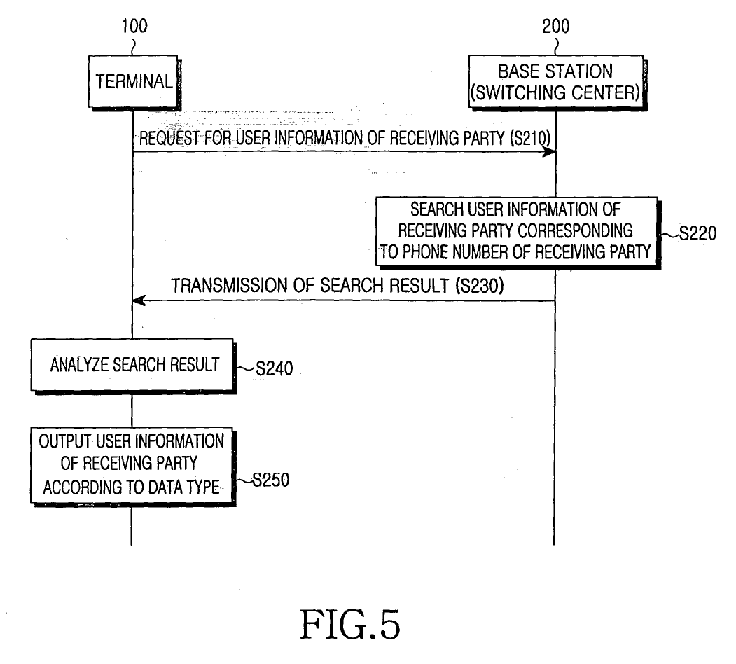

FIG. 5 is a view illustrating a process of providing user information of a receiving party according to an embodiment of the present invention. Referring to FIG. 5, the originating terminal receives the user information of the receiving party from an external information source that in this case resides in an external network connection device, and provides the user information to the originating party. In this embodiment, the network connection device that supports the external information source comprises a base station (or switching center) 200, and the terminal 100 is wirelessly connected to the base station 200.

At this time, it is assumed that the external information source within base station 200 is comprised of a user information management database section (not illustrated) for storing/managing user information (for example, name, sex, age, etc.) of subscribers of network services such as PSTN or PLMN.

Referring to FIG. 5, if the terminal 100 of the originating party requests the user information of the receiving party that corresponds to the inputted phone number from the base station 200 (step S210), the base station 200 searches for the user information of the receiving party by searching the user information management database section (not illustrated) (step S220), and transmits results of the search to the terminal 100 of the originating party (step S230). The search results include the user information or an indication that user information for the phone number is not stored in the database. Then, the terminal 100 of the originating party analyzes results of the search (step S240). Specifically, the terminal 100 determines whether the search results include user information of the receiving party that corresponds to the corresponding phone number. If it is confirmed that user information was received, the terminal 100 determines the data type of the user information of the receiving party. Thereafter, the terminal of the originating party provides the user information of the receiving party to the originating party according to its data type (step S250), that is, by display or audio output. As the method of outputting the user information of the receiving party according to its data type has already been explained with reference to FIGS. 2 to 4, the detailed explanation thereof will be omitted here.

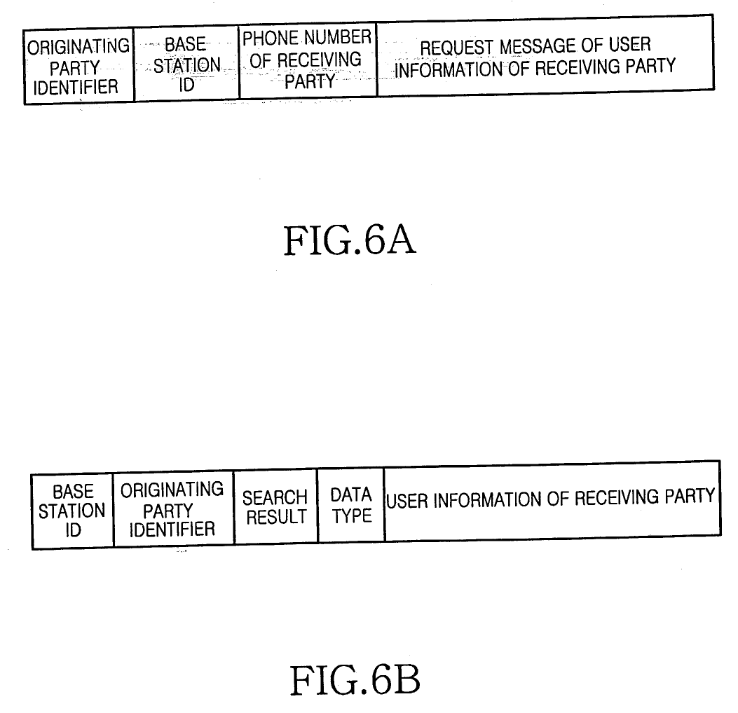

FIGS. 6A and 6B are views illustrating an example of a data format transmitted/received between the terminal and the base station for providing user information of the receiving party according to an embodiment of the present invention.

FIG. 6A shows an example of a data format transmitted by the terminal 100 of the originating party to request the user information of the receiving party to the base station 200 at step S210 of FIG. 5. Referring to FIG. 6A, the data format that the terminal 100 of the originating party transmits to the base station 200 in order to request the user information of the receiving party includes at least the fields of originating party identifier, base station ID, phone number of receiving party, and request message of user information of receiving party.

Meanwhile, FIG. 6B shows an example of a data format transmitted by the base station 200 to transmit a result of a search to the terminal 100 at step S230 of FIG. 5. Referring to FIG. 6B, the data format that the base station 200 transmits to the terminal 100 in order to transmit the search result includes at least the fields of a base station ID, originating party identifier, search result, data type, and user information of receiving party.

At this time, the search result field is a field for informing whether the user information of the receiving party that corresponds to the phone number requested by the terminal 100 is in the user information management database section stored in the base station 200 and whether the user information can be open to the public. That is, the search result field is a field where the search result of the base station 200 is written as a predetermined value mutually recognized between the base station 200 and the terminal 100. For example, if it is recognized that if the user information corresponding to the phone number requested by the terminal 100 is either not in the base station 200 or its open to the public is rejected, “0” is written in the search result field. If user information is included and is publicly available, ‘1’ is written. The base station 200 writes ‘0’ or ‘1’ in the search result field according to the search result, and the terminal 100 of the originating party determines the existence/nonexistence of user information in the search result by reading the value.

FIGS. 6A and 6B show an example of the data format that is transmitted/received through the base station 200 and the terminal 100 to transfer the user information of the receiving party in response to the request of the terminal 100 of the originating party, but the type of the data format is not limited to that illustrated in FIGS. 6A and 6B.

As described above, according to the present invention, if the originating party inputs a phone number to the terminal and requests a call, the user information that corresponds to the phone number of the receiving party is detected from the internal memory of the terminal or is received from a network device such as a base station or switching center, in order to display the user information of the receiving party on the terminal of the originating party. Thus, the user information of the receiving party can be provided to an originating party that requested the originating call service irrespective of whether or not the information of the receiving party is included in the terminal of the originating party.

Accordingly, the user can confirm whether he/she correctly inputted the phone number as well as request a call. Also, in case that the user remembers a phone number only, but does not remember the name of the receiving party, he/she can refer to the user information.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A communication terminal comprising:
a speaker;
a display for displaying an operational state of the terminal and contents of external inputs to the terminal;
a communication interface for providing a communication interface with an external network device;
a memory for storing user information for phone numbers registered by a user; and
a main processor for retrieving from the memory the user information of a receiving party corresponding to a phone number of the receiving party inputted to the terminal when an originating call service via the terminal is requested, requesting the user information of the receiving party corresponding to the phone number of the receiving party that is not registered in the memory from the external network device through the communication interface, and providing the user information of the receiving party transferred from the external network device to an originating party through at least the speaker and the display.

2. The communication terminal of claim 1, wherein the memory stores and manages the user information for each registered phone number in the form of at least one of voice data, text data and image data.

3. The communication terminal of claim 1, wherein the main processor provides the user information of the receiving party to the originating party prior to a time of call connection with the terminal of the receiving party.

4. A method of providing user information of a receiving party for a communication terminal of an originating party, the method comprising:
a first step of requesting the user information of the receiving party that corresponds to a phone number of the receiving party inputted to the terminal from an external information source when an originating call service is requested; and
a second step of providing to the originating party the user information of the receiving party received from the external information source in response to the request of the first step.

5. The method of claim 4, wherein the second step provides the user information in the form of at least one of voice, text and image.

6. The method of claim 4, wherein the second step provides the user information of the receiving party to the originating party prior to a time of call connection with the terminal of the receiving party.

7. A method of providing user information of a receiving party for a communication terminal of an originating party, the method comprising:
a first step of determining whether the user information of the receiving party that corresponds to a phone number of the receiving party inputted to the terminal is registered in an internal memory of the terminal of the originating party when an originating call service through the terminal is requested;
a second step of providing to the originating party the user information of the receiving party that corresponds to the phone number of the receiving party if registered in the internal memory of the terminal of the originating party;
a third step of requesting from an external information source the user information of the receiving party that corresponds to the phone number of the receiving party that is not registered in the internal memory of the terminal of the originating party; and
a fourth step of providing to the originating party the user information of the receiving party received from the external information source in response to the request at the third step.

8. The method of claim 7, wherein the second step provides the user information in the form of at least one of voice, text and image.

9. The method of claim 7, wherein the fourth step provides the user information in the form of at least one of voice, text and image.

10. The method of claim 7, wherein the fourth step provides the user information to the originating party prior to a time of call connection with the terminal of the receiving party.

11. A method of providing user information for a network connection device supporting a call service between a communication terminal and a network, the method comprising:
a first step of constructing a user information management database section for storing the user information of service subscribers for using a call service supported through the network connection device;
a second step of detecting the user information of a receiving party that corresponds to a phone number of the receiving party transmitted from the communication terminal from the user information management database section in response to a request for the user information of the receiving party from the terminal that requested an originating call service; and
a third step of transmitting to the terminal the detected user information of the receiving party based on a predetermined data format.

12. The method of claim 11, wherein the first step constructs the user information management database for storing the user information of the service subscribers in the form of at least one of voice, text and image.
